(19) United States
(12) Patent Application Publication
(10) Pub. No.: US 2011/0148801 A1
(43) Pub. Date: Jun. 23, 2011

(54) TOUCH PANEL REGION OF INTEREST REPORTING SCHEME

(76) Inventors: Steven S. Bateman, Portland, OR (US); David L. Graumann, Portland, OR (US); John J. Valavi, Beaverton, OR (US)

(21) Appl. No.: 12/641,796

(22) Filed: Dec. 18, 2009

(51) Int. Cl. G06F 3/045

(52) U.S. Cl. 345/174

(57) ABSTRACT

A system and method provide for receiving touch panel raw data and identifying data of interest in the raw data. One or more events may be detected based on the data of interest and a touch processing policy. In one example, the receiving and the identifying are conducted by a touch panel controller, and the detecting is conducted by a host processor. Other techniques, such as subsurface scanning and hybrid scanning may also be used.

### BACKGROUND

1. Technical Field

Embodiments generally relate to touch panels. More particularly, embodiments relate to improved techniques of processing raw data from touch panels.

2. Discussion

Touch panels can be deployed as user interfaces (UIs) in a wide variety of situations. Typically, a touch panel includes internal controller firmware that processes raw data and detects finger touches. These finger touches may be reported by the firmware as events to other system components for application specific processing. Such an approach may have limitations due to the implementation of finger touch event detection in firmware, which may be difficult to upgrade and/or modify, and could have processing capability limitations.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a computing system according to an embodiment;

FIG. 2 is a flowchart of an example of a method of identifying regions of interest according to an embodiment;

FIG. 3 is a flowchart of an example of a method subsurface scanning according to an embodiment;

FIG. 4 is a flowchart of an example of a method of hybrid scanning according to an embodiment;

FIG. 5 is a diagram of an example of a computing system having a touch panel and a housing with a notebook form factor according to an embodiment.

### DETAILED DESCRIPTION

Embodiments may provide for a method in which touch panel raw data is received. Data of interest may be identified in the raw data, and an event can be detected based on the data of interest and a touch processing policy. The receiving and the identifying can be conducted by a touch panel controller, and the detecting may be conducted by a host processor.

Embodiments can also provide an apparatus including a touch panel controller, firmware, a host processor and a machine readable medium. The firmware can have a stored set of controller instruction which, if executed by the touch panel controller, cause the touch panel controller to receive touch panel raw data and identify data of interest in the raw data. The machine readable medium may include a stored set of processor instructions which, if executed by the host processor, cause the host processor to detect an event based on the data of interest and a touch processing policy.

In addition, embodiments may include a computing system having a housing with a notebook form factor, and a touch panel. The touch panel can have a touch sensor, a touch panel controller and firmware with a stored set of controller instructions which, if executed by the touch panel controller, cause the touch panel controller to receive touch panel raw data from the touch sensor. The controller instructions may also cause the touch panel controller to identify data of interest in the raw data. In addition, the computing system can have a host processor and a machine readable medium with a stored set of processor instructions which, if executed by the host processor, cause the host processor to detect an event based on the data of interest and a touch processing policy. The touch processing policy might include a debounce component, a finger detection component, a hand rest detection component, a blob detection component, a specific hand shape detection component, and/or a sub-hand shape detection component. The processor instructions may also cause the processor to forward the event to another process such as an operation system (OS) navigation process and/or an on-screen keyboard application process.

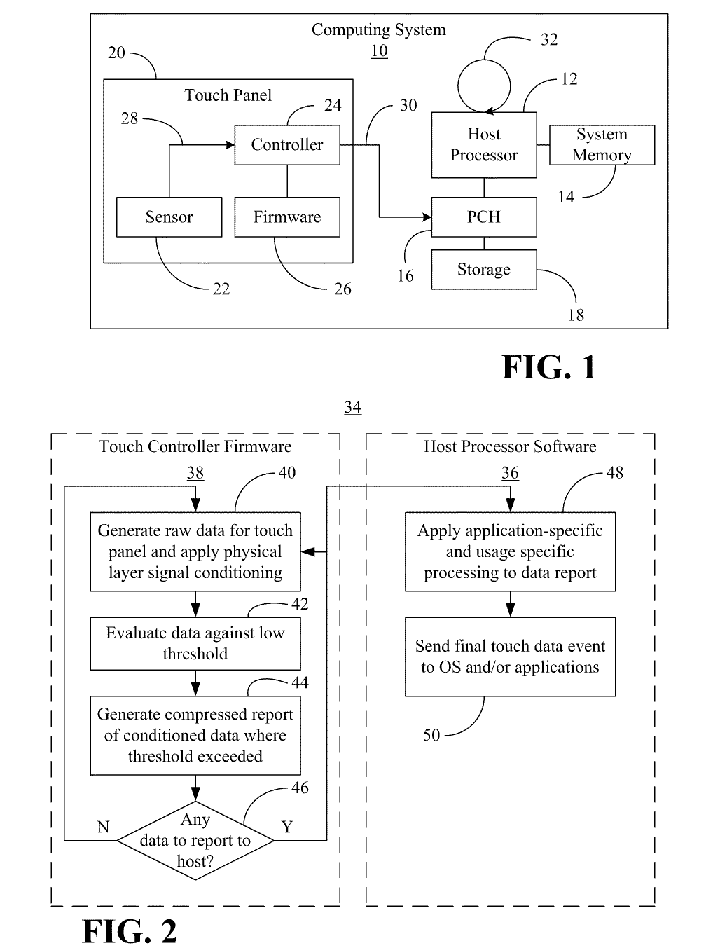

Turning now to FIG. 1, a computing system 10 is shown, wherein the system 10 may be part of a mobile platform such as a laptop, personal digital assistant (PDA), wireless smart phone, media player, imaging device, etc., or any combination thereof. The system 10 may also be part of a fixed platform such as a personal computer (PC), server, workstation, etc. The illustrated system 10 includes a host processor 12 that might include an integrated memory controller (not shown) that provides access to system memory 14, which could include dual data rate (DDR) synchronous dynamic random access memory (SDRAM, e.g., DDR3 SDRAM JEDEC Standard JESD79-3C, April 2008) modules. The modules of the system memory 14 may be incorporated into a single inline memory module (SIMM), dual inline memory module (DIMM), small outline DIMM (SODIMM), and so on. The processor 12 may also have one or more processor cores (not shown), where each core may be fully functional with instruction fetch units, instruction decoders, level one (L1) cache, execution units, and so on. In one example, the internal cache(s) of the processor 12 could be implemented in static RAM (SRAM). The processor 12 may also execute an operating system (OS) such as a Microsoft Windows, Linux, or Mac (Macintosh) OS, and various other software applications.

The illustrated processor 12 communicates with a platform controller hub (PCH) 16, also known as a Southbridge in certain systems. The PCH 16 may have internal controllers (not shown) such as USB (Universal Serial Bus, e.g., USB Specification 2.0, USB Implementers Forum), Serial ATA (SATA, e.g., SATA Rev. 3.0 Specification, May 27, 2009, SATA International Organization/SATA-IO), High Definition Audio, and other controllers. The illustrated PCH 16 is also coupled to one or more mass storage devices 18, which may include a hard drive, read only memory (ROM), optical disk, flash memory, etc. The PCH 16 could provide support for user interface devices such as a microphone, display, keypad, mouse, speakers, etc., in order to allow a user to interact with and perceive information from the system 10.

In particular, the PCH 16 may communicate with a touch panel 20 that has a touch sensor 22, a touch panel controller 24 and firmware 26. The controller 24 might be an embedded controller implemented in fixed-functionality hardware logic using circuit technology such as application specific integrated circuit (ASIC), complementary metal oxide semiconductor (CMOS) or transistor-transistor logic (TTL) technology, or any combination thereof. In the illustrated example, the firmware 26, which might be implemented as logic in programmable ROM (PROM) or flash memory, includes a set of controller instructions which, if executed by the controller 24, cause the controller 24 to receive touch panel raw data 28 from the touch sensor 22, and identify data of interest 30 in the raw data 28. The data of interest 30 may be passed to the host processor 12 via the PCH 16 for further processing.

In particular, machine readable media such as the mass storage device 18, system memory 14 or internal caches of the processor 12 may include a stored set of processor instructions which, if executed by the processor 12, cause the processor 12 to detect one or more events 32 based on the data of interest 30 and a touch processing policy. The touch processing policy, which may be readily modified via a software upgrade, might include, for example, a debounce algorithm component, a finger detection component, a hand rest detection component, a non-finger (e.g., blob) detection component, a specific hand shape detection component, and/or a sub-hand shape detection component. The processor instructions may also cause the processor 12 to forward the events 32 to other software components such as an OS navigation process or an on-screen keyboard application process.

Thus, the illustrated approach enables the system 10 to apply varying touch processing policies to the data of interest 30 without changing the firmware 26 or adding to the gate count within the controller 24. When appropriate, the much greater processing capability of the host processor 12 can be applied to extract the most value from the touch panel raw data 28. The touch processing policy can be changed on-demand at run time, or via an upgrade, which may be easier to accomplish on the machine readable media used by the host processor 12 than in the firmware 26. For example, when supporting an on-screen keyboard usage, different data tracking and filtering rules may be appropriate compared with the tracking and filtering rules applied when navigating the OS. Also, in an expanding/non-mature usage area like human computer interaction using touch, the ability to quickly upgrade functionality may be critical to realizing market value for the computing system 10.

Moreover, a key concept may be allowing the host processor 12 to idle when no data of interest 30 is present, which can be advantageous for mobile computers and handheld devices that are battery powered. In addition, sending the data of interest rather than the entire touch panel raw data 28 may help to minimize the amount of host processing and bandwidth required.

FIG. 2 shows a method 34 of identifying regions of interest in touch panel raw data in greater detail. The method 34 may be implemented in executable software as a set of logic instructions stored in a machine- or computer-readable medium of a memory such as random access memory (RAM), read only memory (ROM), programmable ROM (PROM), flash memory, etc., in fixed-functionality hardware using circuit technology such as application specific integrated circuit (ASIC), complementary metal oxide semiconductor (CMOS) or transistor-transistor logic (TTL) technology, or any combination thereof. For example, computer program code to carry out operations shown in a software process 36 of the method 34 may be written in any combination of one or more programming languages, including an object oriented programming language such as Java, Smalltalk, C++ or the like and conventional procedural programming languages, such as the “C” programming language or similar programming languages. On the other hand, fixed-functionality hardware or lower-level instructions such as assembly language programming or machine code might be used to carry out operations shown in a firmware process 38 of the method 34.

As already noted, the touch controller firmware process 38 and host processor software process 36 can cooperatively operate using a predefined software interface and an established division of responsibility for the data processing. The illustrated touch controller firmware process 38 is responsible for managing the physical sensing of the touch panel and applying low-level corrections to the raw data to assure data linearity and other correction factors to compensate for variations due to environmental factors such as temperature and unit to unit variation, and a calibrated zero operating point/baseline. Thus, processing block 40 may provide for generating raw data for the touch panel and applying physical layer signal conditioning to the raw data. The touch controller firmware process 38 can also have the responsibility for detecting data of interest by applying a relatively low threshold to the raw data or other means. Thus, illustrated block 42 provides for evaluating the raw data against the threshold. The touch controller developer may select this threshold based on knowledge of expected noise levels and the physical nature of the touch sensor. Only areas and areas two-dimensionally adjacent to where data exceeds the threshold might be categorized as “interesting”. No other policy or action need be applied to the data by the firmware process 38.

Block 44 provides for generating a compressed report of conditioned data where the threshold is exceeded. Block 46 may provide for detecting data of interest for every fixed touch panel scan interval, and if any exists, forwarding the data of interest to the host processor for further processing. The host software process 36 may remain idle until it receives a data report from the firmware process 38. The host software process 36 can then analyze and process the data. For example, application-specific and usage specific processing can be applied to the data report at block 48. In particular, the current touch processing policy may be applied to the data, wherein the touch processing policy could include any one or any combination of the following depending on the current system usage model: specific and different debounce algorithms, finger detection, hand rest detection, non-finger (blob) detection, specific hand shape or sub-hand shape detection. The host processing algorithm can then forward the detected events to the operating system or directly to applications as appropriate at block 50.

Simply put, the illustrated method 34 can help to minimize data traffic and host processing while preserving the ability to perform usage-model specific data processing. In addition, these techniques may enable host processing of touch panel data while preserving host battery life. Host processing of touch panel data could enable advanced and usage-specific touch capabilities on a standard set of touch sensing hardware/firmware.

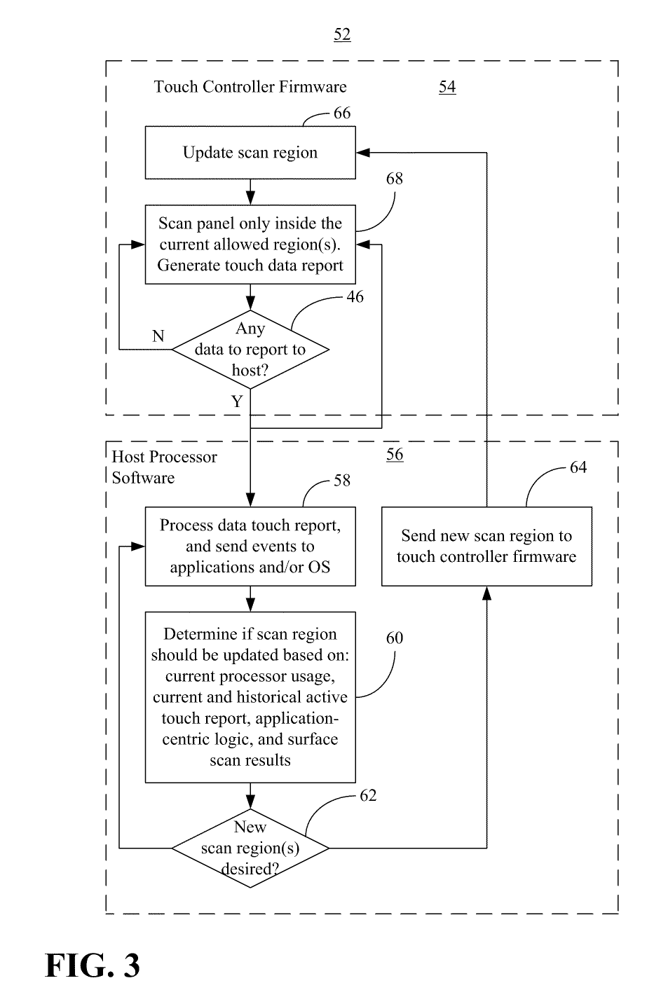

Turning now to FIG. 3, a method 52 of “subsurface scanning” is shown. Generally, subsurface scanning can be utilized in conjunction with the above techniques or separately. In many projected capacitive touch systems, each x/y data point that is scanned can cost the system a unit of time by consuming analog to digital converter time and data communication and processing time. In many systems there may be a direct trade off between time to scan the panel and the number of data points being scanned. This tradeoff may be “non-linear”, however, depending on the specific design of the panel and the specific data points in question, due to hardware parallelization or other design choices. Rather than attempting to scan the entire surface of the touch sensor in a minimum unit of time, illustrated subsurface scanning approach can reduce the scanning of areas that are known a-priori to be not of interest.

For example, a static region of interest around an active area such as a keyboard could be defined, or a dynamic, discontiguous region around touches from the last scan could be defined. Reducing scanning outside of the region of interest may free up time that can be used in a number of ways: (1) the touch controller can idle, reducing power consumption, and (2) the touch controller firmware can utilize the time by repeating data measurements in a region of interest, for example in x/y locations where touch is currently occurring. By generating extra data points in these areas, the effective scan rate of areas where touch is currently occurring may be increased. An increase in scan rate can be very beneficial to noise mitigation, averaging for position determination, and tracking processing algorithms.

Thus, the illustrated method 52 includes a touch controller firmware process 54 and a host software process 56, in which processing block 58 provides for processing a data touch report containing data of interest, and sending one or more events to other applications and/or the OS. Block 60 provides for determining if the scan region used by the firmware process 54 should be updated based on one or more factors such as, current processor usage, the current active touch report, an historical active touch report, application-centric logic and a surface capacitance scan result. If it is determined at block 62 that based on these factors a new scan region is needed, illustrated block 64 provides for sending the new scan region to the touch controller firmware process 54, where the scan region may be updated at block 66.

Block 68 provides for scanning only the portion of the touch panel that is within the scan region to obtain the raw data and generating a touch data report as already described with regard to blocks 42 and 44 (FIG. 2). If it is determined at block 46 that there is any data to report to the host software process 56, a report containing such data may be transmitted by the controller firmware process 54.

Thus, the method 52 may enable a capacitive touch solution to control, in software, the area that is being scanned. In particular, the capacitive touch solution can overscan an area of the touch panel while ignoring other areas of the panel. Since areas of a touch screen being touched are generally more interesting to the system, this aspect can increase the performance of a touch sensing solution and/or decrease touch sensing cost as less hardware is required for the average human-computer touch scenario.

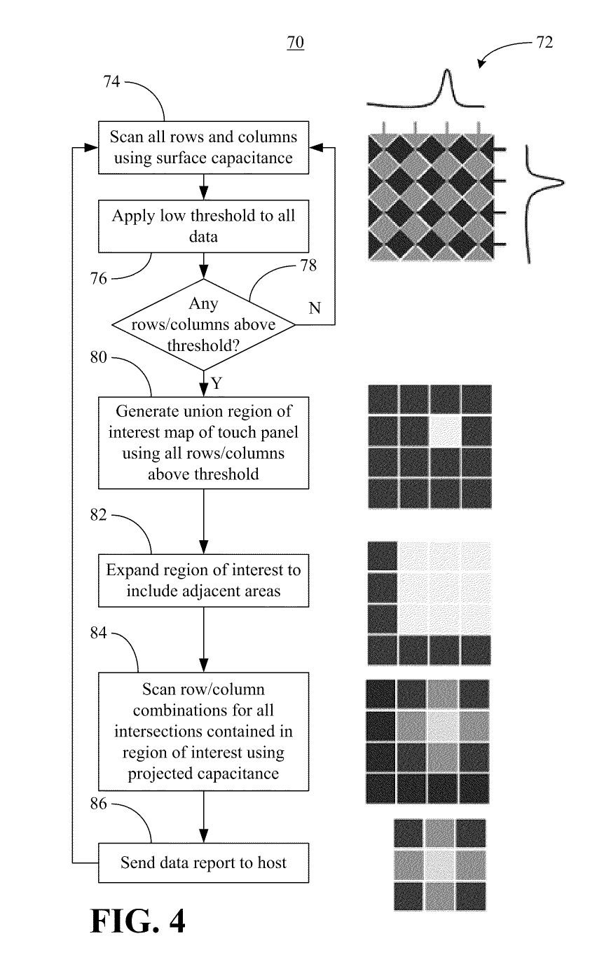

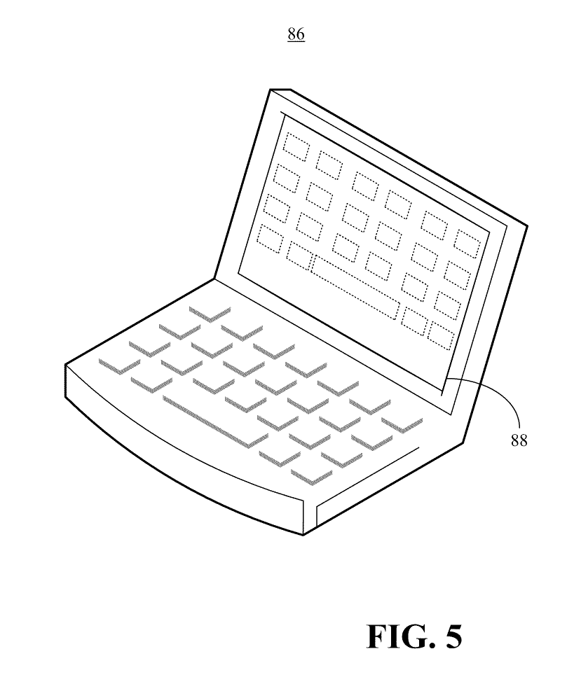

FIG. 4 shows a method 70 of “hybrid scanning” in conjunction with a visual example 72. Generally, the illustrated method 70 may be implemented in touch controller firmware to perform both surface capacitance and projected capacitance. In particular, the touch controller can use surface capacitance as a pre-measurement to determine areas of the touch panel where touches are occurring. Thus, block 74 may provide for conducting a surface capacitance scan of the touch panel, and illustrated block 76 applies a relatively low threshold to the resulting raw data to obtain a region of interest in the touch panel. If it is determined at block 78 that any of the scanned rows/columns exceed the threshold, the touch controller may then use projected capacitance to scan only the row/column intercepts of rows and columns that were determined to contain touches during the previous surface capacitance measurement. Thus, block 80 can provide for generating a union region of interest map of the touch panel using the rows/columns that are above the threshold. In addition, the region of interest can be expanded at block 82 to include one or more areas adjacent to the original region of interest. Block 84 provides for conducting a projected capacitance scan of the expanded region of interest to identify the data of interest. The resulting data report can be sent to the host software process at block 86.

The result may be that all areas of the panel where touches are occurring can be scanned using projected capacitance, and areas that do not contain touches can be skipped. Accordingly, there may be an average increase in panel scan rate, particularly in systems where average occurring touches are a small percentage of the total touch panel (e.g., single or multiple finger touches). The faster average scan rate can allow less costly hardware to support a given touch sensor glass size. This technique may be particularly useful with larger touch panels still designed for a single user (e.g., notebook form factors).

Moreover, in a surface capacitance measurement, an entire row or column can be measured at once resulting in a single scalar measurement. Typically, every row and column is scanned providing 2 single-dimensional arrays of data. The scan time for such a measurement, for a non-parallelized hardware system, is equal to surface capacitance scan time*(number of rows+number of columns). In a projected capacitance measurement, on the other hand, each row/column intersection might be scanned individually (or in some parallel fashion depending on touch controller/touch sensor design), resulting in a two-dimensional bitmap of scalar data. Thus, the scan time for such a measurement, for a non-parallelized touch sensing system, is equal to projected capacitance scan time*(number of rows*number of columns). Thus, the illustrated reduction in the number of rows and columns to scan using projected capacitance can be particularly advantageous.

Simply put, hybrid scanning may optimize scanning rates by enabling the touch solution to quickly identify areas where touches are present and only performing the full projected capacitance scan on those areas. Elevating scan rates can help to enable larger touch panels with the same hardware or raise the average scan rate of a given touch panel.

FIG. 5 shows a mobile computing system 86 having a housing with a notebook form factor, and a touch panel 88. As already noted, the touch panel 88 may include a touch sensor, a touch panel controller and firmware configured to identify data of interest in raw data obtained from the touch sensor. In addition, the system 86 may include a host processor configured to support region of interest processing, subsurface scanning, and hybrid scanning, as already discussed. In the illustrated example, host processor of the system 86 is configured to run an on-screen keyboard application process. Other processes might include OS navigation processes (e.g., touch computing to refresh the computing system), etc.

Embodiments of the present invention are applicable for use with all types of semiconductor integrated circuit (“IC”) chips. Examples of these IC chips include but are not limited to processors, controllers, chipset components, programmable logic arrays (PLA), memory chips, network chips, and the like. In addition, in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” is used herein to refer to any type of relationship, direct or indirect, between the components in question, and may apply to electrical, mechanical, fluid, optical, electromagnetic, electromechanical or other connections. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computing system comprising:
a housing having a notebook form factor;
a touch panel having a touch sensor, a touch panel controller and firmware with a stored set of controller instructions which, if executed by the touch panel controller, cause the touch panel controller to,
receive touch panel raw data from the touch sensor, and
identify data of interest in the raw data;
a host processor; and
a machine readable medium comprising a stored set of processor instructions which, if executed by the host processor, cause the host processor to,
detect an event based on the data of interest and a touch processing policy, wherein the touch processing policy includes at least one of a debounce component, a finger detection component, a hand rest detection component, a blob detection component, a specific hand shape detection component and a sub-hand shape detection component, and
forward the event to at least one of an operating system navigation process and an on-screen keyboard application process.

2. The computing system of claim 1, wherein the stored set of processor instructions are to cause the processor to,
generate a scan region based on at least one of a current processor usage, a current active touch report, an historical active touch report, application-centric logic, and a surface capacitance scan result, and
transmit the scan region to the touch panel controller, and
the stored set of controller instructions are to cause the touch panel controller to,
scan only a portion of the touch panel that is within the scan region to obtain the raw data.

3. The computing system of claim 1, wherein the stored set of controller instructions are to cause the touch panel controller to,
conduct a surface capacitance scan of the touch panel to obtain a region of interest in the touch panel,
transmit a result of the surface capacitance scan to the host processor,
expand the region of interest to include an area adjacent to the region of interest, and
conduct a projected capacitance scan of the expanded region of interest to identify the data of interest.

4. The computing system of claim 1, wherein the firmware includes at least one of a read only memory (ROM) and a flash memory, and the machine readable medium includes a random access memory (RAM).

5. An apparatus comprising:
a touch panel controller;
firmware comprising a stored set of controller instructions which, if executed by the touch panel controller, cause the touch panel controller to,
receive touch panel raw data, and
identify data of interest in the raw data;
a host processor; and
a machine readable medium comprising a stored set of processor instructions which, if executed by the host processor, cause the host processor to,
detect an event based on the data of interest and a touch processing policy.

6. The apparatus of claim 5, wherein the stored set of processor instructions are to cause the processor to forward the event to at least one of an operating system process and an application process.

7. The apparatus of claim 5, wherein the touch processing policy includes at least one of a debounce component, a finger detection component, a hand rest detection component, a blob detection component, a specific hand shape detection component and a sub-hand shape detection component.

8. The apparatus of claim 5, wherein the stored set of processor instructions are to cause the processor to, generate a scan region, and
transmit the scan region to the touch panel controller, and
the stored set of controller instructions are to cause the touch panel controller to,
scan only a portion of the touch panel that is within the scan region to obtain the raw data.

9. The apparatus of claim 8, wherein the stored set of processor instructions are to cause the processor to generate the scan region based on at least one of a current processor usage, a current active touch report, an historical active touch report, application-centric logic, and a surface capacitance scan result.

10. The apparatus of claim 5, wherein the stored set of controller instructions are to cause the touch panel controller to,
conduct a surface capacitance scan of the touch panel to obtain a region of interest in the touch panel,
expand the region of interest to include an area adjacent to the region of interest, and
conduct a projected capacitance scan of the expanded region of interest to identify the data of interest.

11. The apparatus of claim 10, wherein the stored set of controller instructions are to cause the touch panel controller to transmit a result of the surface capacitance scan to the host processor.

12. The apparatus of claim 5, wherein the firmware includes at least one of a read only memory (ROM) and a flash memory, and the machine readable medium includes a random access memory (RAM).

13. A method comprising:
receiving touch panel raw data;
identifying data of interest in the raw data; and
detecting an event based on the data of interest and a touch processing policy, wherein the receiving and the identifying are conducted by a touch panel controller, and the detecting is conducted by a host processor.

14. The method of claim 13, further including forwarding the event to at least one of an operating system process and an application process.

15. The method of claim 13, wherein the touch processing policy includes at least one of a debounce component, a finger detection component, a hand rest detection component, a blob detection component, a specific hand shape detection component and a sub-hand shape detection component.

16. The method of claim 13, further including:
generating a scan region;
transmitting the scan region to the touch panel controller; and
scanning only a portion of the touch panel that is within the scan region to obtain the raw data, wherein the generating and transmitting are conducted by the host processor and the scanning is conducted by the touch panel controller.

17. The method of claim 16, wherein the scan region is generated based on at least one of a current processor usage, a current active touch report, an historical active touch report, application-centric logic, and a surface capacitance scan result.

18. The method of claim 13, further including:
conducting a surface capacitance scan of the touch panel to obtain a region of interest in the touch panel;
expanding the region of interest to include an area adjacent to the region of interest; and
conducting a projected capacitance scan of the expanded region of interest to identify the data of interest, wherein conducting the surface capacitance scan, expanding the region of interest and conducting the projected capacitance scan are conducted by the touch panel controller.

19. The method of claim 18, further including transmitting a result of the surface capacitance scan to the host processor.

20. The method of claim 13, further including modifying the touch processing policy via a software upgrade.
